(19) United States
(12) Patent Application Publication
(10) Pub. No.: US 2002/0126189 A1
(43) Pub. Date: Sep. 12, 2002

(54) Systems and methods for lithography

(76) Inventor: Daniel F. Gloster, Somerville, MA (US)

Correspondence Address: FOLEY, HOAG & ELIOT, LLP, PATENT GROUP, ONE POST OFFICE SQUARE, BOSTON, MA, 02109, US

(21) Appl. No.: 09/961,031

(22) Filed: Sep. 21, 2001

Related U.S. Application Data
(60) Provisional application No. 60/234,146, filed on Sep. 21, 2000.

(51) Int. Cl. G01D 11/00

(52) U.S. Cl. 347/100

(57) ABSTRACT

The systems and methods described herein relate to lithographic printing processes which utilize ink jet techniques to prepare lithographic plates. Images, such as text and pictures, can be printed onto the lithographic plates using a basic ink formulation in conjunction with a lithographic plate having a coating that polymerizes in the presence of base.

### RELATED APPLICATIONS

The present application claims the benefit of U.S. patent application Ser. No. 60/234,146, “Systems and Methods for Lithography” filed Sep. 21, 2001, which is hereby incorporated by reference in its entirety.

### FIELD OF THE INVENTION

The systems and methods described herein relate to a process for fabricating a lithographic printing plate using ink jet technology.

### BACKGROUND 0F THE INVENTION

Lithography and offset printing methods have long been combined in a compatible marriage of great convenience for the printing industry for economical, high speed, high quality image duplication in small runs and large. Known art available to the industry for image transfer to a lithographic plate is voluminous but dominated by the photographic process wherein a hydrophilic plate is treated with a photosensitive coating, exposed via a film image and developed to produce a printable, oleophilic image on the plate.

While preparing lithographic plates by photographic image transfer is relatively efficient and efficacious, it is a multi-step, indirect process of constrained flexibility. Typically, a photographically presensitized (PS) plate is prepared from a hydrophilically surface-treated aluminum. A positive or negative film image of an original hard copy is prepared and the PS plate exposed to the film image, developed, washed and made ready for print operations. Any desired changes in the film image must be made by first changing the original hard copy and repeating the photographic process; hence, the constrained flexibility. As sophisticated and useful as it is to prepare plates by photographic image transfer, the need for a lithographic plate fabricating process that obviates the above problems associated with the photographic process has long been recognized. Clearly, it would be highly beneficial to the printing industry to directly produce a quality printable image on a plate without proceeding through a multi-step photographic process. It would also be highly efficacious if a process were developed whereby changes could be made in an original image in some predetermined manner without incurring the need to correct hard copy and repeat the photography, particularly if those changes could be made “on-line”.

Digital computer-aided design of graphical material or text is well known. Electronically derived images of words or graphics presented on the CRT of a digital computer system can be edited and converted to final hard copy by direct printing with impact printers, laser printers or ink jet printers. This manner of printing or producing hard copy is extremely flexible and useful when print runs of no more than a few thousand are required but the print process is not feasible for large runs measured in the tens or hundreds of thousands of pieces. For large runs, printing by lithographic plate is still the preferred process with such plates prepared by the process of photographic image transfer.

It is known that digitized image information can be used in plate making wherein a film is made to express the image according to the image information digitization and an image is formed on the plate by exposure and development. While this method augments flexibility by permitting editing of a digitized image, the method does not overcome the problems associated with the photographic image transfer method of plate fabrication.

Recently, fabrication of lithographic plates by ink jet techniques has been proposed. One such technique is disclosed in Japanese patent application, Kokai 62-25081. This application describes the use of an ink jet system for applying an oleophilic liquid to form an image on the hydrophilic aluminum surface of a lithographic plate. This approach retains the materials and processing of conventional lithographic printing plates and only uses ink jet printing as an alternative in the photomask through which the conventional plates are exposed. U.S. Pat. No. 5,495,803 describes a solid or phase change type of ink jet printing to form a photomask for a printing plate. Thus, these approaches simply are variants of the above platemaking process and do not utilize the ink jet ink image as the hydrophobic image of the plate.

U.S. Pat. No. 4,833,486 discloses the use of an ink jet head to deposit a hot wax upon the surface of a lithographic plate. The hot wax solidifies upon contact with the plate, thus providing an instantaneous printing pattern. Plates prepared by this method are useful for limited print runs of a few thousand pieces.

There are several advantages for fabricating printing plates by ink jet printers. One advantage is that such processes are environmentally friendly. The complex and potentially polluting chemical preparations and solvents ordinarily used in masking and stripping away photoresist areas of the plates are not always required with ink jet techniques.

The ink jet technology, however, is in its infancy with respect to commercial lithography. Present ink jet techniques cannot readily produce large or commercially acceptable offset plates. That is, the plates produced by present ink jet techniques generally have very low plate runs by commercial lithographic standards. Furthermore, there is no ink jet apparatus or process presently available for fabricating large offset plates having a plurality of pages disposed thereon. Indeed, U.S. Pat. No. 4,833,486 teaches that ink jet materials are inexpensive, and therefore, the printing plate may be used a minimum number of times and then discarded. Moreover, in one embodiment of the '486 patent, it is indicated that the system is designed for non-commercial plate production, inasmuch as an office processor system is proposed. Office processing systems ordinarily are not capable of providing the large amounts of digital information required to produce large, commercial lithographic plates.

A further drawback of the apparatus disclosed in the '486 patent is that it makes use of an ink jet medium which may be a wax. Wax is a soft material and may abrade with use under the conditions present for commercial offset printing. Even the so-called hard waxes may not provide the durability required for commercial printing runs of the order of 100,000 cycles. Moreover, waxes do not strongly bond to the printing plate surface, i.e., they prefer to remain on the surface, rather than to actively bond to the substrate.

A liquid ink amenable to ink jet technology that provides a stable, durable image on a lithographic plate would simplify and reduce the costs of applying ink jet technology to lithographic printing techniques.

### SUMMARY OF THE INVENTION

The present invention relates in part to printing fluids having a basic pH which react with a photosensitive coating of a lithographic plate to form a durable image suitable for lithographic printing. Such fluids, whether or not they contain any colorant or dye, are referred to herein as inks.

Thus, in one aspect, the invention provides an ink formulation including about 40 to about 95 weight percent water, or about 40 to about 90 weight percent water, or about 40 to about 85 weight percent water, or about 40 to about 80 weight percent water, or about 40 to about 70 or 75 weight percent water; up to about 50 weight percent of humectant, or about 5 to about 50 weight percent humectant, or about 10 to about 50 weight percent humectant, or about 15 to about 45 percent humectant, or about 20 to about 45 weight percent humectant, or about 25 to about 50 weight percent humectant, or about 25 to about 40 weight percent humectant; and less than about 5 weight percent of surfactant, or less than about 2 weight percent of surfactant, or less than about 1 or even less than about 0.5 weight percent surfactant; wherein the ink formulation has a pH greater than about 8, or greater than about 9, or in the range of about 9 and about 11. In certain embodiments, the formulation comprises at least about 5 percent humectant, and/or at least about 0.001 weight percent surfactant, and/or a biocide, and optionally a dye or other colorant.

In one embodiment an ink formulation includes about 40 to about 90 weight percent water, about 5 to about 50 percent humectant, and about 0.001 to about 5 percent surfactant, wherein the ink formulation has a pH greater than about 8, e.g., in the range of about 9 to about 11. In certain embodiments, the formulation comprises between about 25 and about 50 weight percent humectant, and/or between about 40 and about 75 weight percent water. The formulation may further comprise a biocide and/or a dye or other colorant. In certain embodiments, the formulation comprises at least about 0.001 weight percent surfactant, and may comprise less than about 1 weight percent, or less than about 0.5 weight percent surfactant.

An ink as described above may include, as a basic component, a basic salt of an alkali metal or alkaline earth metal, e.g., including a cation selected from lithium, sodium, potassium, rubidium, cesium, magnesium, calcium, and strontium, and/or an anion selected from bicarbonate, carbonate, metasilicate, orthosilicate, trisilicate, borate, hydroxide, and phosphate.

In another aspect, the present invention provides an ink jet cartridge comprising an ink formulation as set forth above, or, in yet another aspect, an ink jet printer loaded with such an ink formulation, and, optionally, a lithographic plate coated with a substance that polymerizes or hardens when contacted with the ink.

In still another aspect, the present invention relates to a method of preparing an ink formulation as described above. Thus, in one exemplary embodiment, an ink may be prepared by combining about 40 to about 95 weight percent water, up to about 50 weight percent of humectant, less than about 5 weight percent of surfactant, and a basic salt, whereby the formulation has a pH greater than about 8, or by combining about 40 to about 90 weight percent water, about 5 to about 50 percent humectant, and about 0.001 to about 5 percent surfactant, and a basic salt, whereby the formulation has a pH greater than about 8. In such embodiments, the method may further include adding a colored dye, disposing the ink formulation in an ink jet cartridge, loading the ink in an ink jet printer, and the like.

In yet another embodiment, the present invention provides a method of placing an image on a lithographic plate by providing a lithographic plate having a polymerizable coating disposed thereon, and depositing an image on the lithographic plate with an ink formulation as set forth above. The polymerizable coating may polymerize in the presence of base to form a solid residue. Depositing an image may be performed using an ink jet printer or any other printing technique, as will be apparent to one of skill in the art. In certain embodiments, the polymerizable coating is hydrophilic, and the solid residue is oleophilic, or is insoluble in an aqueous solvent, e.g., water. For example, the polymerizable coating may be soluble or may absorb or adsorb water or an aqueous solvent, while the solid residue is substantially resistant to water, e.g., does not significantly absorb or adsorb water, or dissolve in water.

### DETAILED DESCRIPTION OF SELECTED EMBODIMENTS

The description below pertains to several possible embodiments of the invention. It is understood that many variations of the systems and methods described herein may be envisioned by one skilled in the art, and such variations and improvements are intended to fall within the scope of the invention. Accordingly, the invention is not to be limited in any way by the following disclosure of certain illustrative embodiments.

The systems and methods described herein relate to inks having a basic pH, and to methods of using such inks to polymerize a coating disposed on a lithographic plate, thereby leaving a stable, polymerized residue where the ink has contacted the coating. For example, aqueous base may initiate the polymerization of a photosensitive diazo resin in a fashion similar to the decomposition/polymerization caused by exposure to light. An ink, as the term is used herein, refers to a liquid composition, which, when disposed on portions of a surface, alters a physical characteristic of the contacted surface such that afterwards the contacted surface may be differentiated from the non-contacted surface. Inks having a pH in the range of about 8 to about 12 or higher are capable of initiating this polymerization. Accordingly, a stable, basic ink may replace or augment a light source as the means by which an image is fixed to a photosensitive lithographic printing plate. In certain embodiments, the ink is suitable for use in an ink jet printer. For use in the offset lithographic process, the residue resulting from polymerization of the coating, optionally after a curing step, such as heat treatment, is preferably oleophilic and sufficiently robust to satisfy the requirements of commercial lithographic offset printing.

Any suitable base may be employed to provide an ink with a basic pH. Examples of suitable compounds include alkali metal or alkaline earth metal salts of carbonate, bicarbonate, phosphate (including dibasic and tribasic forms), metasilicate, acetate, hydroxide, methoxide, ethoxide, tartrate, etc.

Inks useful in the systems and methods described herein may include visible dyes or colorants, such as dyes used in conventional inks, or may rely entirely on the reaction of the basic ink with the polymerizable coating to provide an image or residue on a lithographic plate. Suitable inks may have pH values greater than about 8, or between about 9 and about 11, for example. In certain embodiments, the inks are aqueous inks, e.g., comprise at least about 30% water, or at least about 50% water, or even more than about 60% water. The inks may further comprise one or more of the following additive types: surfactants, biocides, and humectants.

In certain embodiments, the ink includes a surfactant, such as a non-ionic surfactant, sodium decyl diphenyl oxide disulfonate, alkyloxypolyethyleneoxyethanol, polyoxypropylene methyl diethyl ammonium chloride, or combinations thereof. Surfactants, as the term is used herein, include compounds having a hydrophilic (e.g., polar or ionic) moiety and a hydrophobic (i.e., non-polar or lipophilic) moiety, such as alkyl sulfates or phosphates, alkylammonium salts, etc. Surfactants which may be utilized in inks of the present invention include but are not limited to Surfynol 420, 440, 465, 485, 502, 504, SE-F, and DF-110D (available from Air Product and Chemicals Inc.), Tergitol 15-S-7, 15-S-9, 15-S-12, 15-S-15, 15-S-20, 15-S-30, and 15-S-40 (Union Carbide Chemicals & Plastics Company Inc.), Strodex PK-90, Dextrol OC 50, OC 20, OC 75A, and OC 78N (Henley Chemicals), Dewet SMA-80 and SDIB-45 (DeForest Enterprises), Pilot Calfax 16L-35 and 10L-45 (Pilot Chemical Company), Witcol EMCOL CC9 and CC36 (Witco Corporation), Dowfax 3BO, 2AO, 8390, and 2A1 (The Dow Chemical Company), Sokalan CP-7, CP-10, CP-10 S, and CP-9 (BASF), Aerosol MA 80-1, OTNV, OT-75, and OT-75 PG (Cytec), Zonyl FSJ, FSD, FSO, FSA, FS-300 (DuPont), Fluorad FC-129 and FC-170-C (3M), and Iconol NP-30, NP-40, NP-50, NP70, NP100, DA-4, DA-6, DA-9, TDA-8 TDA-9, and TDA-10 (BASF Corporation).

In certain embodiments, the ink includes a biocide, such as 1,2-benzisothiazolin-3-one, 2-methyl-4,5-trimethylene-4-isothiazolin-3-one, 1-(3-chloroallyl)-3,5,7-triaza-1-azoniaadamantane, 6-acetoxy-2,4-dimethyl-1,3-dioxane, or a combination thereof, to prevent growth of organisms in the ink during storage. A biocide is any compound which inhibits the growth of microbes or other life forms, such as yeast, bacteria, algae, or fungus, in the ink.

In certain embodiments, the ink includes a humectant, such as glycerin, propylene glycol, ethylene glycol, 1,5-pentanediol, di(ethylene glycol), tri(ethylene glycol), poly(ethylene glycol) mw200-1200, poly(propylene glycol) mw200-1200, di(propylene glycol), tri(propylene glycol), ethoxylate, poly(ethylene glycol)-300, 2-propanol, 1,4-butanediol, ethanol, N-methylpyrrolidone, pentaerythritol, 1,3-dimethyl-2-imidazolidinone, 2-pyrrolidone, thiodiglycol, dimethyl imidazolidinone, glycerin, acetamide, urea, N-methyl urea, N-allyl urea, ethoxylated glycerin, sorbitol, ethoxylated glucose, dimethoxyethane, diethoxyethane, ethyleneglycol diacetate, glycinamide hydrochloride, or a combination thereof. The humectant may provide the ink with leveling properties on substrates, or serve to inhibit drying in the nozzles of the printer, and thus clogging of the nozzles.

Polymerizable coatings are coatings which comprise a component which, when exposed to base, polymerize to form a stable, durable residue bound to the support. In certain embodiments, the polymerizable coating is water-soluble, but upon polymerization yields a coating which is insoluble in and/or repels water (e.g., is hydrophobic, or oleophilic). For example, a diazo resin may be employed as a polymerizable coating, such as benzidine tetrazonium chloride, 3,3′-dimethylbenzidine tetrazonium chloride, 3,3′-dimethoxybenzidine tetrazonium chloride, 4,4′-diaminodiphenylamine tetrazonium chloride, 3,3′-diethylbenzidine tetrazonium sulfate, 4-aminodiphenylamine diazonium sulfate, 4-aminodiphenylamine diazonium chloride, 4-piperidinoaniline diazonium sulfate, 4-diethylamino aniline diazonium sulfate and oligomeric condensation products of diazodiphenylamine and formaldehyde. Other examples of diazo resins useful in the present invention include condensation products of an aromatic diazonium salt as the light-sensitive substance. Such condensation products are known and are described, for example, in German Pat. No. 1214086. They may be prepared by condensation of a polynuclear aromatic diazonium compound, including substituted or unsubstituted diphenylamine-4-diazonium salts, with active carbonyl compounds, such as formaldehyde, in a strongly acid medium, for example. Additional examples of polymerizable coatings are described in U.S. Pat. Nos. 5,462,833, 5,922,511, 4,186,069, 3,181,461, and in Kosar, Light-sensitive Systems, John Wiley and Sons, Inc.: New York (1965).

In certain embodiments, the polymerizable coating may contain dispersed water-insoluble polymers. The water-insoluble polymer may be a solid particulate having a size, for example, in the range of about 100 Angstroms to 1 micron in diameter. Suitable polymers include homopolymers and copolymers of styrene, methylacrylate, ethylacrylate, butylacrylate, methylmethacrylate, ethylmethacrylate, butyl methacrylate, vinyl acetate, vinyl chloride, vinylidene chloride, butadiene, methyl styrene, vinyl toluene, dimethylaminoethyl acrylate, acrylic acid, methacrylic acid, isoprene, chloroprene, maleic anhydride, ethylene glycol acrylates such as polyethylene glycol acrylate, halogenated vinyl aromatics such as chlorostyrene and bromostyrene, methylvinyl ether, vinyl pyrrolidone, polyurethane, latex, and the like. In certain embodiments, the water-insoluble polymer does not absorb or adsorb water, i.e., is substantially hydrophobic.

The thickness of the polymerizable coating in the material of this invention may vary in the range of 0.1 to 10 μm and is preferably between 0.5 and 2.5 μm.

Supports useful for carrying a polymerizable coating as described above include paper, plastic or polymer film or sheets, metals such as aluminum, or any other material suitable for use in an ink jet printing system, as is well known in the art.

In certain embodiments, the printed image may benefit from being treated or cured, such as by exposure to heat. Heat treatment may be accomplished by heating the support and/or polymerizable coating prior to, during, or after the printing process itself. For example, ink may be printed directly onto a heated surface, or the printed image may afterwards be exposed to a heat source. In certain embodiments, the plate may be heated after the printing process, but before being developed. Thus, for example, a plate printed with an ink as described herein may be heated (e.g., to about 200 F. for about 1.5 min), developed (e.g., by techniques known in the art, as may depend on the composition of the coating), and heated again (e.g., to 350 F. for about 1 min.).

The systems and methods disclosed herein also include ink jet printers containing a basic ink. The systems and methods disclosed herein also include ink jet printer cartridges, such as replacement ink cartridges, containing a basic ink as described herein.

The systems and methods described above will be elucidated by reference to the following exemplification and examples which serve to illustrate particular embodiments of the present invention and are not intended to limit the scope of the invention.

Exemplification

### EXAMPLE 1

As a means to investigate compatibility between a basic ink and ink jet printer and printhead components, a series of basic ink solutions, having pHs of 9.0, 9.5, 10.0, 10.5, and 11.0, were printed using an Epson Stylus Color 3000 printer. A computer program was devised that would print the standard Epson Stylus Color nozzle check and a dot pattern for each ink cartridge every three hours. The quality of the printed patterns at the end of the test period was indicative of the condition of the printer/printhead. As an additional test, the printheads were removed from the printer and examined by microscopy. There was no detectable degradation of the printhead after prolonged printing with these inks, nor was print quality adversely affected by the test run.

A sodium carbonate/sodium bicarbonate buffer was selected as the starting point for developing a basic ink. Solutions including both bases were prepared at 0.2 M concentrations. By varying the ratio of carbonate to bicarbonate, solutions with pHs ranging between 9.2 and 10.7 can be achieved. Three inks were prepared that incorporated this buffer system. A: 0.2 M sodium bicarbonate (40 g), 0.2 M sodium carbonate (40 g), glycerin (15 gr), GXL (0.2 g), surfynol 485 and surfynol TG (0.5 g and 0.3 g, respectively), direct turquoise (0.5 g); B: 0.2 M sodium bicarbonate (20 g), 0.2 M sodium carbonate (60 g), glycerin (15 g), GXL (0.2 g), surfynol 485 and surfynol TG (0.5 g and 0.3 g, respectively), direct turquoise (0.5 g); dfg04-143C: 0.2 M sodium bicarbonate (20 g), 0.2 M sodium carbonate (60 g), Liponic EG-1 (15 g), GXL (0.2 g), surfynol 485 and surfynol TG (0.5 g and 0.3 g, respectively), direct turquoise (0.5 g). All of the inks marked the plates used in these experiments, an aqueous-based photosensitive emulsion comprising diazonium salts that has been coated onto an aluminum support, and had dot sizes between 90 μm and 100 μm.

### EXAMPLE 2

The print quality of Epson black ink on the PS layer of a lithographic plate is superb. It does not, however, produce an image that can be developed. Epson black ink and a series of inks, comprised of different surfactants, were dropped onto the photosensitive diazo resin/latex layer of a lithographic plate (obtained from Precision Lithograining Corporation, South Hadley, Mass.). Inks comprising Tergitol 15-S-7, Tergitol 15-S-9, Iconol TDA 10, and Calfax 10L-45 behaved most like Epson black ink. Other surfactants investigated were: Aerosol MA 80-1 (dihexyl ester of sodium sulfosuccinic acid), Surfynol 485 (ethoxylated tetramethyl decyndiol), Tergitol 15-S-9, Tergitol 15-S-7 (C11-C15 secondary alcohol ethoxylate), Aerosol OT-75 PG, Fluorad FC-129, Fluorad FC-170-C (fluorocarbon surfactant), Calfax 10-L-45, Calfax 16L-35 (sodium n-hexadecyl diphenyl disulfonate), Witco Emcol CC-36, Iconol DA-4 (ethoxylated decyl alcohol), Iconol TDA-10 (ethoyxlated tridecyl alcohol), Zonyl FSJ, Zonyl FSD, Zonyl FSO, Zonyl FSA, Zonyl FS-300 (fluorocarbon surfactant), Strodex PK-90 (phosphate ester), Dowfax 8390 (sodium n-hexadecyl diphenyloxide disulfonate), Dextrol OC 50, Dextrol OC 20, Aerosol OTNV, Aerosol OT-75 (dioctyl ester of sodium sulfosuccinic acid), Dowfax 2A-1, Dewet SMA-80, Dewet SDIB-45, Dowfax 3BO (n-decyl diphenyloxide disulfonate), Dowfax 2AO (dodecyl diphenyloxide disulfonate), Sokalan CP-7, Sokalan CP- 10, Sokalan CP-10S, Tergitol 15-S-15, Tergitol 15-S-40, Sokalan CP-9, Dextrol OC 75A, and Dextrol OC 78 (phosphate ester) were incorporated into inks. An ink containing one or more of the surfactants listed above gave ink droplets of approximately 50 μm that penetrated the photosensitive coating and effectively generated hydrophobic polymerized layers that formed a robust image when the plate was heated, developed, and reheated.

1

A stock ink vehicle was prepared by combining magenta dye (15.0 g), glycerin (75 g), GXL (1,2-benzisothiazolon-3-one, biocide, 1.0 g), 0.2 M sodium carbonate (300 g), and 0.2 M sodium bicarbonate (100 g). Four inks were made by combining stock ink vehicle (99.5 g) with Tergitol 15-S-7 (0.5 g), Tergitol 15-S-9 (0.5 g), Iconol TDA-10 (0. 5 g), and Calfax 10L-45(0.5 g) to give inks 1A-D, respectively. The dot sizes of the developed dot patterns were approximately 100 μm, 80 μm, 100 μm, and 60 μm for inks dfg04-148A, dfg04-148B, dfg04-148C, and dfO04-148D, respectively.

### EXAMPLE 3

Experiments were performed to investigate the influence of humectants and their effect upon the penetration of ink into a photosensitive diazo resin/latex dispersion on a lithographic plate. A series of humectants were evaluated as described above for surfactants. Glycerin, diethylene glycol, ethylene glycol, polyethylene glycol 200, polyethylene glycol 300, polyethylene glycol 400, polyethylene glycol 600, liponic EGI, propylene glycol were all formulated and examined. Polyethylene glycol 300 was found to provide a particularly well-behaved ink.

2

Humectants Liponic EGI, diethylene glycol, polyethylene glycol 300, and butyl cellusolve along with surfactants Calfax 10L-45, Calfax 16L-35, Strodex PK 90, Zonyl FSO, Zonyl FS-3D, and Fluorad FC-170-C were incorporated into a general formula of 0.2 M sodium carbonate (60 g), 0.2 M sodium bicarbonate (20 g), GXL (0.2 g), dye (3 g), humectant (15.0 g), and surfactant (0.5 g). Ink 2A including polyethylene glycol 300 and Strodex PK-90 as the humectant and surfactant, respectively, performed the best in subsequent evaluations.

The solubility properties of the photosensitive (PS) layer with individual humectants and surfactants were investigated in order to gain insight into which humectants and surfactants might prove successful in an ink. In some cases the photosensitive layer was dissolved away leaving clear aluminum. In other cases the strength of the PS layer was softened that it was easily rubbed off. For example, diethylene glycol dissolved the PS layer. The PS layer was softened when treated with ethylene glycol, glycerin, and propylene glycol. Liponic EG-1, polyethylene glycol 300, and butyl cellusolve did not seem to dissolve the PS layer.

This same test was carried out with a series of surfactants. Both Calfax 10L-45 and 16L-35 dissolved the PS layer. Zonyl FSJ, FSD, and FSA dissolved the PS layer. Strodex PK-90, Zonyl FSO, Zonyl FS-300 and Fluorad FC-170C did not dissolve the PS layer.

From the information gained from these solubility experiments nine inks were made that comprised a combination of humectants: Liponic EG-1, diethylene glycol, and polyethylene glycol 300 with each of the following surfactants: Calfax 10L-45, Calfax 10L-35, and Strodex PK-90. Additionally, six other inks were formulated that comprised a polyethylene glycol 300 or butyl cellusove with each of the following surfactants: Zonyl FSO, Zonyl FS-300, and Fluorad FC-170-C. A seventh ink comprising butyl cellusolve and Strodex PK-90 was also formulated.

The inks were spotted onto the PS surface, allowed to stand for approximately 5 minutes, dried with a paper towel and then developed. Inks were differentiated based upon the durability and intensity of the developed spot. The two best inks comprised either polyethylene glycol 300 or diethylene glycol and Strodex PK-90.

The best ink comprised polyethylene glycol 300 and Strodex PK-90 as the humectant and surfactant, respectively. This ink produced approximately 60 μm dots that were more durable than the dots generated with ink 1D.

3

Variations of 2A were prepared and compared. A stock ink vehicle of 0.2 M sodium carbonate (600 g), 0.2 M sodium bicarbonate (300 g), GXL (2.0 g), and Direct Turquoise (30 g) was prepared. Four inks were prepared as follows: 3A polyethylene glycol 300 (15 g), Strodex PK-90 (0.5 g), and stock ink vehicle (84.95 g); 3B diethylene glycol (15 g), Strodex PK-90 (1.0 g), and stock ink vehicle (84.0 g); 3C polyethylene glycol 300 (7.5 g), butyl cellusolve (7.5 g), Zonyl FSO (0.5 g), and stock ink vehicle (84.95 g); 3D polyethylene glycol 300 (7.5 g), butyl cellusolve (7.5g), Strodex PK-90 (0.5 g), and stock ink vehicle (84.95 g).

Inks 3A and 3B performed the best in subsequent tests. 3A produced plates capable of printing over 8000 impressions. 3B produced plates which functioned for 200 impressions or fewer. 3C and 3D produced plates useful for print runs of fewer than about 20 and 500 impressions, respectively, and did not give good differentiation of high-density print areas; the regions above 65% coverage transferred about the same amount of ink onto the print medium.

### EXAMPLE 4

Abrasion resistance is a desirable characteristic of an ink intended to produce hydrophobic layers on a lithographic aluminum plate. Inks were made from a matrix that included polyethylene glycol 300, 400, 600, Zonyl FS-300, Fluorad FC-170-C, Strodex PK-90, and stock ink vehicle. The inks were dropped onto a commercially available lithographic plate that had a coating comprising diazo resin and latex dispersion. The spots were allowed to stand for approximately five minutes at which time the plate was developed with standard plate developer. (SD-100, Precision Lithograining Corporation; includes water, sodium toluene sulfonate, benzyl alcohol, and surfactants) The images left behind (round spots that corresponded to the droplets) were digitally abraded. Although the different inks performed similarly, it was clear that abrasion resistance greatly improved with post-development heating.

4

Four new inks were formulated. The stock ink vehicle of 3 was combined with Calfax 10L-45 (0.5 g) and either Liponic EGI (12.0 g) 4A, glycerin (15 g) 4B, polyethylene glycol 300 4C, or polyethylene glycol 400 4D. The weight of each complete ink was 100 g. The dot sizes for the inks 4A, 4B, 4C, and 4D were 56 μm, 60 μm, 60 μm, and 56 μm. These inks generated plates useful for less than 520-page pressruns. The ink comprising Liponic EGI jetted well. The other inks jetted blobs and uneven lines when the Epson Stylus Color nozzle check was executed.

Fresh stock ink was prepared by combining Direct Turquoise (30 g), GXL (2.0 g), 0.2 M sodium carbonate (600 g), and 0.2 M sodium bicarbonate (200 g). Two inks were made by adding enough stock ink vehicle to humectant-surfactant combinations of polyethylene glycol 300 (15.0 g) and Strodex PK-90 (0.5 g), or diethylene glycol (15 g) and Strodex PK-90 (1.0 g), so that the total weight of each ink was one hundred grams.

### EXAMPLE 5

Many of the inks formulated above produce lithographic plates serviceable for fewer than about one thousand impressions. One theory proposed to account for the short pressrun was that the base reacts with the silica-terminated aluminum on the surface of the plate, weakening the bond to the surface and reducing the print life. Using a basic liquid including a silicate solute, such as sodium metasilicate, might counteract this difficulty. Sodium metasilicate, as well as other silicate solutes, is sufficiently basic to act as the base in the ink, as well. Two inks were formulated based upon this logic. The first ink was formulated from Liponic EGI (12 g), Strodex PK-90 (0.5 g), dye (3.0 g), and a 1% aqueous solution of sodium metasilicate (84.5 g). The second ink was formulated from polyethylene glycol 300 (15 g), Strodex PK-90 (0.5 g), dye (3.0 g), and a 1% aqueous solution of sodium metasilicate (81.5 g).

### EXAMPLE 6

An ink was formulated without the reaction-initiating ingredient so that the effect of the ink vehicle upon the hardness of the developed image could be investigated. Neutral ink vehicle (vehicle without base) was to be printed onto the photosensitive lithographic plate that would then be air dried prior to being exposed to developing irradiation. The effect of the ink vehicle upon printlife would be determined by comparing the number of prints obtained from this plate with the number of prints obtained from a control plate developed by conventional irradiation. The neutral ink vehicle was formulated from polyethylene glycol 300 (15 g) Strodex PK-90 (0.5 g), and an alkali-free ink vehicle (84.95 g). The alkali-free ink vehicle was formulated from direct turquoise (3.0 g), GXL (0.2 g), and water (80.0 g).

### EXAMPLE 7

An ink formulated from polyethylene glycol (150 g), Strodex PK-90 (5.0 g), and stock ink vehicle (845 g) was prepared for stress testing. The stock ink vehicle was 0.2 M sodium carbonate (600 g), 0.2 M sodium bicarbonate (200 g), GXL (2.0 g), direct turquoise (10 g), and water (20 g). Initial values for pH, conductivity, surface tension, and viscosity are: 10.52, 12.8 ms, 26.0 dynes/cm, and 2.27 centipoise, respectively. After three days in the oven at 60 ° C. the values, in the same order as above, are: 10.19, 13.0 ms, 26.4 dynes/cm, and 2.16 centipoise.

### EXAMPLE 8

A series of inks based upon the most successful vehicle, differing only in their surfactant, were formulated and printed. The inks include polyethylene glycol 300 (7.5 g), surfactant (0.5 g), and stock ink vehicle (42.25 g). The stock ink vehicle was dye (20 g), GXL (4.0 g), 0.2 M sodium carbonate (1200 g), and 0.2 M sodium bicarbonate (400 g). The surfactants evaluated were: Dowfax 8390, Dextrol OC-50, Dextrol. OC-20, Aerosol OTNV, Aersol OT-75, Aerosol MA-80-1, Dowfax 2A-1, Dewet SMA-80, Dewet SDIB-45, Calfax 10L-45, Calfax 16L-35, Dowfax 3BO, Dowfax 2AO, Zonyl FSJ, Zonyl FSA, Sokalan CP-7, Sokalan CP-10, Sokalan CP-10S, Tergitol 15-S-15, Tergitol 15-S-40, Sokalan CP-9, Dextrol OC-75A, and Dextrol OC-78N. Of the twenty-three inks, the ink comprising Dowfax 3BO provided the best results.

### EXAMPLE 9

3A has been the most successful ink to date. The purpose of this experiment was to determine if the ink would improve if the dye and/or the strength of the buffer system were varied. 3A was the only ink in these experiments that comprised a cyan dye. The first and simplest experiment was to determine if the choice of dye would change the print quality. The general formula for 3A was followed except that a magenta dye was used instead of a cyan dye. The next investigation focused upon buffer strength. Two inks were formulated to investigate the influence of buffer strength upon print quality. 9A was made by combining a 0.4 M solution of sodium bicarbonate (20 g), 0.4 M solution of sodium carbonate (60 g), GXL (0.2 g), Strodex PK-90 (0.5 g), polyethylene glycol 300 (15 g), and magenta dye (4.3 g). 9B was made by combining a 0.8 M solution of sodium bicarbonate (20 g), 0.8 M solution of sodium carbonate (60 g), GXL (0.2 g), Strodex PK-90 (0.5 g), polyethylene glycol 300 (15 g), and magenta dye (4.3 g). Another ink was formulated to investigate what affect surfactant would have upon print quality. 9C was prepared by combining a 0.2 M solution of sodium bicarbonate (20 g), 0.2 M solution of sodium carbonate (60 g), GXL (0.2 g), Dowfax 3BO (0.5 g), polyethylene glycol 300 (15 g), and magenta dye (4.3 g). 9D and 9E were prepared using sodium metasilicate as a base. 9D was prepared by combining a 5% solution of sodium metasilicate (40 g), GXL (0.1 g), Strodex PK-90 (0.25), polyethylene glycol (7.5 g), and magenta dye (2.15 g). 9E was prepared by combining a 5% solution of sodium metasilicate (40 g), GXL (0.1 g), Dowfax 3BO (0.25 g), polyethylene glycol (7.5 g), and magenta dye (2.15 g).

9A produced good dots about 60 μm in diameter. 9B jetted dots that were ragged and measured between 80 μm and 100 μm in diameter. Both 9C and 9E produced ragged dots that had an average diameter>100 μm. Both 9D and 9F jetted double dots of a diameter 30 μm or less.

### EXAMPLE 10

Since the surfactant survey identified Dowfax 3BO as the best surfactant, we prepared a series of inks that incorporated this surfactant.

In an attempt to improve jetting, the percentage of the humectant was raised from 15% to 20% for two inks; one (10A) based upon 3A and the other (10B) based upon Example 8. 10A was prepared by combing a 3/1 wt % solution of 0.2 M sodium carbonate/sodium bicarbonate (75.2 g), magenta dye (4.3 g), polyethylene glycol (20 g), and Strodex PK-90 (0.5 g). 10B was prepared by combing a 3/1 wt % solution of sodium carbonate/sodium bicarbonate (75.2 g), magenta dye (4.3 g), polyethylene glycol (20 g), and Dowfax 3BO (0.5 g).

The increase in humectant did not keep 10A from flooding the plate in areas of high density, although the dot size was about 60 μm in diameter. 10B gave a dot size ˜45 μm and did not flood the plate.

### EXAMPLE 11

To date the most successful formulation was 10B. That formulation was scaled up with the addition of biocide, and two other variants were formulated: one with a higher concentration of polyethylene glycol and the other with a mixture of polyethylene glycol and 2-pyrrolidone. 11A was prepared by combining a (3/1 wt %) solution of 0.2 M sodium carbonate/sodium bicarbonate (752 g), GXL (2.0 g), magenta dye (41 g), polyethylene glycol 300 (200 g), and Dowfax 3BO (5 g). 11B was prepared by combining a (3/1 wt %) solution of 0.2 M sodium carbonate/sodium bicarbonate (75.2 g), GXL (0.2 g), magenta dye (4.1 g), polyethylene glycol 300 (10 g), 2-pyrrolidone (10 g), and Dowfax 3BO (5 g). liC was prepared by combining a (3/1 wt %) solution of sodium carbonate/sodium bicarbonate (70.2 g), GXL (0.2 g) magenta dye (4.1 g), polyethylene glycol 300 (25 g), and Dowfax 3BO (0.5 g)

### EXAMPLE 12

A large series of inks, based upon 11A were prepared.

| | 12A | 12B | 12C | 12D | 12E | 12F | 12G |
|---|---|---|---|---|---|---|---|
| grams | grams | grams | grams | grams | grams | grams | |
| Dowfax 3BO | 0.5 | 0.5 | 0.5 | 0.5 | 0.5 | 0.5 | 0.5 |
| PEG-300 | 30 | 30 | 38 | 15 | 10 | 15 | 10 |
| Magenta dye | 4.1 | 4.1 | 4.1 | | | | |
| Cyan dye | | | | 4 | 4 | 4 | 4 |
| GXL | 0.2 | 0.2 | 0.2 | 0.2 | 0.2 | 0.2 | 0.2 |
| Buffer solution A | 65.8 | | | 80.3 | 90.3 | | |
| Buffer solution B | | 65.8 | 57.8 | | | 80.3 | 90.3 |

| | 12H | 12I | 12J | 12K | 12L |
|---|---|---|---|---|---|
| grams | grams | grams | grams | grams | |
| Dowfax 3BO | 0.5 | 0.5 | 0.5 | 0.5 | 0.5 |
| Strodex PK-90 | 0.15 | 0.07 | 0.1 | 0.1 | 0.1 |
| PEG-300 | 20 | 20 | 25 | 30 | 38 |
| Magenta dye | | | | | |
| Cyan dye | 4 | 4 | 4 | 4 | 4 |
| GXL | 0.2 | 0.2 | 0.2 | 0.2 | 0.2 |
| Buffer solution A | 75.15 | 75.23 | 70.2 | 65.2 | 57.2 |
| Buffer solution B | | | | | |
| | 60 μm dots | | | 60 μm dots | ˜50 μm dots |
| | blobs | | | | |

The buffer solution A was prepared by combining 600 g 0.2 M sodium carbonate and 200 g 0.2 M sodium bicarbonate
The buffer solution B was prepared by combining 600 g 0.1 M sodium carbonate and 200 g 0.1 M sodium bicarbonate

All patents and publications cited herein are hereby incorporated by reference in their entirety.

While the invention has been disclosed in connection with the embodiments shown and described in detail, various equivalents, modifications, and improvements will be apparent to one of ordinary skill in the art from the above description. Such equivalents, modifications, and improvements are intended to be encompassed by the following claims.

We claim:

1. An ink formulation, comprising
about 40 to about 95 weight percent water,
up to about 50 weight percent of humectant, and
less than about 5 weight percent of surfactant,
wherein the ink formulation has a pH greater than about 8.

2. The formulation of claim 1, wherein the formulation has a pH in the range of about 9 to about 11.

3. The formulation of claim 1, wherein the formulation comprises at least about 5 percent humectant.

4. The formulation of claim 1, further comprising a biocide.

5. The formulation of claim 1, wherein the formulation comprises less than about 1 percent of surfactant.

6. The formulation of claim 1, further comprising a colored dye.

7. The formulation of claim 1, wherein the formulation comprises between about 40 and about 80 weight percent water.

8. An ink formulation, comprising
about 40 to about 90 weight percent water,
about 5 to about 50 percent humectant, and
about 0.001 to about 5 percent surfactant,
wherein the ink formulation has a pH greater than about 8.

9. The formulation of claim 8, wherein the formulation has a pH in the range of about 9 to about 11.

10. The formulation of claim 8, wherein the formulation comprises between about 25 and about 50 percent humectant.

11. The formulation of claim 8, further comprising a biocide.

12. The formulation of claim 8, wherein the formulation comprises less than about 1 percent of surfactant.

13. The formulation of claim 8, further comprising a colored dye.

14. The formulation of claim 8, wherein the formulation comprises between about 40 and about 75 weight percent water.

15. The formulation of claim 1 or claim 8, wherein the formulation comprises a basic salt of an alkali metal or alkaline earth metal.

16. The formulation of claim 15, wherein the basic salt includes a cation selected from lithium, sodium, potassium, rubidium, cesium, magnesium, calcium, and strontium, and an anion selected from bicarbonate, carbonate, metasilicate, orthosilicate, trisilicate, borate, hydroxide, and phosphate.

17. The formulation of claim 8, further comprising a colored dye.

18. An ink jet cartridge comprising an ink formulation of claim 1, 8, or 15.

19. An ink jet printer loaded with an ink formulation of claim 1, 8, or 15.

20. A method of preparing an ink formulation, comprising combining
about 40 to about 95 weight percent water,
up to about 50 weight percent of humectant,
less than about 5 weight percent of surfactant, and
a basic salt, whereby the formulation has a pH greater than about 8.

21. A method of preparing an ink formulation, comprising combining
about 40 to about 90 weight percent water,
about 5 to about 50 percent humectant, and
about 0.001 to about 5 percent surfactant, and
a basic salt, whereby the formulation has a pH greater than about 8.

22. The method of claim 20 or 21, further comprising adding a colored dye.

23. The method of claim 20 or 21, further comprising disposing the ink formulation in an ink jet cartridge.

24. The method of claim 20 or 21, further comprising loading the ink in an ink jet printer.

25. A method of placing an image on a lithographic plate, comprising
providing a lithographic plate having a polymerizable coating disposed thereon, and
depositing an image on the lithographic plate with the ink of claim 1, 8, or 15.

26. The method of claim 25, wherein the polymerizable coating polymerizes in the presence of base to form a solid residue.

27. The method of claim 25, wherein depositing an image is performed using an ink jet printer.

28. The method of claim 26, wherein the polymerizable coating is hydrophilic, and the solid residue is oleophilic.
